(19) United States
(12) Patent Application Publication
(10) Pub. No.: US 2009/0144559 A1
(43) Pub. Date: Jun. 4, 2009

(54) ELECTRONIC DEVICE BOOTED UP WITH SECURITY, A HASH COMPUTING METHOD, AND A BOOT-UP METHOD THEREOF

(75) Inventors: Heon-Soo Lee, Seoul (KR); Jae-Chul Park, Seoul (KR); Hyun-Woong Lee, Suwon-si (KR); Yun-Ho Youm, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 12/249,295

(22) Filed: Oct. 10, 2008

(30) Foreign Application Priority Data
Oct. 12, 2007 (KR) 10-2007-103192

(51) Int. Cl. G06F 21/00

(52) U.S. Cl. 713/189

(57) ABSTRACT

A method for authenticating a public key to execute a process with security, including: invoking a process; reading a public key from a first source; calculating a hash value of the public key with a block encryption algorithm, wherein part of the public key is an initial input value of the block encryption algorithm; reading a hash value from a second source; comparing the calculated hash value to the read hash value to determine if the public key is authentic; and executing the process if the public key is authentic.

### CROSS-REFERENCE TO RELATED APPLICATION

This U.S. non-provisional patent application claims priority under 35 U.S.C. § 119 to Korean Patent Application No. 10-2007-103192 filed on Oct. 12, 2007, the disclosure of which is incorporated by reference herein in its entirety.

### BACKGROUND

1. Technical Field

The present invention relates to booting up electronic devices with security.

2. Discussion of the Related Art

Many kinds of electronic devices begin with boot-up processes to start their operating systems when they are initially powered on or reset. During a boot-up process, a machine command for controlling the fundamental operating characteristics of an electronic device, which is stored in a read-only memory (ROM), resets the electronic device and causes other machine commands to be loaded into a random access memory (RAM). The RAM stores execution programs for enabling the electronic device to implement other functions. For example, while a personal computer is in the boot-up process, a basic input/output system (BIOS) is run to cause an operating system (OS) to be loaded into a RAM from a hard disk drive (HDD) and executed by a central processing unit (CPU).

Other electronic devices, which are booted up, include game consoles, digital recording apparatuses, data base systems, and products including processors that start with initial machine commands, for example. Since boot-up processes determine initial conditions of electronic devices, they may affect the devices' operating parameters, and even how the devices can be used after boot-up. As a result, the modification of an electronic device's boot-up process can lead to a loss in revenue arising from use of the electronic device.

For example, in the electronic game industry, most of the commercial worth of game consoles is derived from income generated by licensing game software played on the game consoles. Therefore, machine commands loaded during boot-up processes function to prohibit illegal duplicates of game software from running on electronic game consoles. However, a user may ‘hack’ a boot process to bypass this restriction. Thus, for at least this reason, there is a need to inhibit hackers from using modified software kernels in boot-up processes.

In the satellite television industry, for example, revenue is generated by providing subscribers with access to a number of channels on the basis of monthly fees paid by the subscribers. Because of this, manufacturers of satellite television receivers have to guarantee that their devices have security in place to prevent illegitimate access to the satellite television service. Accordingly, there is also a need to provide secure boot-up schemes which assure permitted software codes are used while booting up electronic devices.

### SUMMARY OF THE INVENTION

In an exemplary embodiment of the present invention, a method for authenticating a public key to execute a process with security comprises: invoking a process; reading a public key from a first source, calculating a hash value of the public key with a block encryption algorithm, wherein part of the public key is as an initial input value of the block encryption algorithm; reading a hash value from a second source; comparing the calculated hash value to the read hash value to determine if the public key is authentic; and executing the process if the public key is authentic.

Calculating the hash value is carried out by dividing the public key into plurality of bit blocks, providing each of the bit blocks to a respective block cipher as a key, wherein the block ciphers are connected in series, providing part of one of the bit blocks to a first one of the block ciphers as the initial input value, and conducting a block encryption in each of the block ciphers on its input value in accordance with its key.

The hash value is an output of a last one of the block ciphers.

Each block cipher employs an advanced encryption standard algorithm.

The hash value has a smaller number of bits than the public key.

The hash value comprises 128 bits.

In an exemplary embodiment of the present invention, a secure boot-up method for an electronic device comprises reading a public key from a first memory, calculating a first hash value of the public key with a block encryption algorithm; reading a second hash value from a second memory, wherein the second hash value is a hash value of a public key that is permitted for the electronic device and is calculated with the block encryption algorithm; comparing the first hash value with the second hash value; and executing a boot code of the first memory if the first hash value is equal to the second hash value.

Calculating each hash value with the block encryption algorithm is carried out by dividing its respective public key into a plurality of bit blocks, providing each of the bit blocks to a respective block cipher as a key, wherein the block ciphers are connected in series, providing part of one of the bit blocks to a first one of the block ciphers as an initial input value, and conducting a block encryption in each of the block ciphers on its input value in accordance with its key.

Each hash value is an output of a last one of the block ciphers.

Each block cipher employs an advanced encryption standard algorithm.

Each hash value has a smaller number of bits than the public key.

Each hash value comprises 128 bits.

The first memory is a flash memory and the second memory is an electrical fuse memory.

The method is further comprised of calculating a hash value of the boot code of the first memory if the first hash value is equal to the second hash value, decrypting an electronic signature, which is stored in the first memory, with the public key from the first memory, determining whether the hash value of the boot code of the first memory is equal to the decrypted electronic signature, and executing a remainder of the boot code of the first memory if the hash value of the boot code of the first memory is equal to the decrypted electronic signature.

In an exemplary embodiment of the present invention, an electronic device includes a first memory storing a boot code and a public key, a processor executing the boot code, a second memory storing a first hash value, and a block cipher calculating a second hash value from the public key with a block encryption algorithm, wherein part of the public key is an initial input value of the block cipher and wherein the first hash value stored in the second memory is obtained by hashing a public key that is permitted for the electronic device with the block encryption algorithm, which uses part of the public key as its initial input value.

The electronic device further comprises a third memory that stores a boot code, wherein the boot code of the third memory includes command codes that enable the processor to calculate the second hash value from the public key stored in the first memory, to read the first hash value from the second memory, to determine whether the first hash value read from the second memory is equal to the second hash value, and to execute the boot code of the first memory if the first hash value read from the second memory is equal to the second hash value.

The boot code of the first memory includes command codes that enable the processor to calculate a hash value of the boot code of the first memory if the first hash value read from the second memory is equal to the second hash value, to decrypt an electronic signature, which is stored in the first memory, with the public key from the first memory, to determine whether the hash value of the boot code of the first memory is equal to the decrypted electronic signature, and to terminate a boot-up process if the hash value of the boot code of the first memory is not equal to the decrypted electronic signature.

The block cipher comprises a plurality of encryption blocks connected to each other in series, each receiving a key value and an initial value, and wherein each encryption block, except a first one of the encryption blocks receives an output of a previous encryption block as the input value.

The public key from the first memory is divided into a plurality of bit blocks respective to the plurality of encryption blocks, each bit block is provided to its corresponding encryption block as the key value and the first one of the plurality of encryption blocks receives part of the public key as the initial input value.

Each hash value has a smaller number of bits than its respective public key.

Each hash value comprises 128 bits.

The first memory is a flash memory and the second memory is an electrical fuse memory.

The electronic device further includes an internal memory, wherein the internal memory, the processor, and the electrical fuse memory are integrated on a single chip.

During a boot-up process, the processor first executes a boot code stored in the internal memory and next executes the boot code of the flash memory that is external to the single chip.

The processor and the electrical fuse memory may be integrated on a single chip and the flash memory may be external to the single chip, wherein during a boot-up process, the processor executes the boot code of the flash memory after executing an initial boot code stored in the flash memory.

### BRIEF DESCRIPTION OF THE DRAWINGS

The above and other features of the present invention will become more apparent by describing in detail exemplary embodiments thereof with reference to the accompanying drawings in which:

FIG. 1 is a block diagram of an electronic device according to an exemplary embodiment of the present invention;

FIG. 2 shows a public key divided into four blocks to obtain a hash value thereof, in accordance with an exemplary embodiment of the present invention;

FIG. 3 is a block diagram of a block cipher shown in FIG. 1 in accordance with an exemplary embodiment of the present invention;

FIG. 4 is a flow chart showing a boot-up process of the electronic device of FIG. 1, in accordance with an exemplary embodiment of the present invention; and

FIG. 5 is a block diagram of an electronic device according to an exemplary embodiment of the present invention.

### DETAILED DESCRIPTION OF EXEMPLARY EMBODIMENTS

Exemplary embodiments of the present invention will be described more fully hereinafter with reference to the accompanying drawings.

The present invention may, however, be embodied in many different forms and should not be construed as limited to the embodiments set forth herein. Like reference numerals refer to like elements throughout the accompanying drawings.

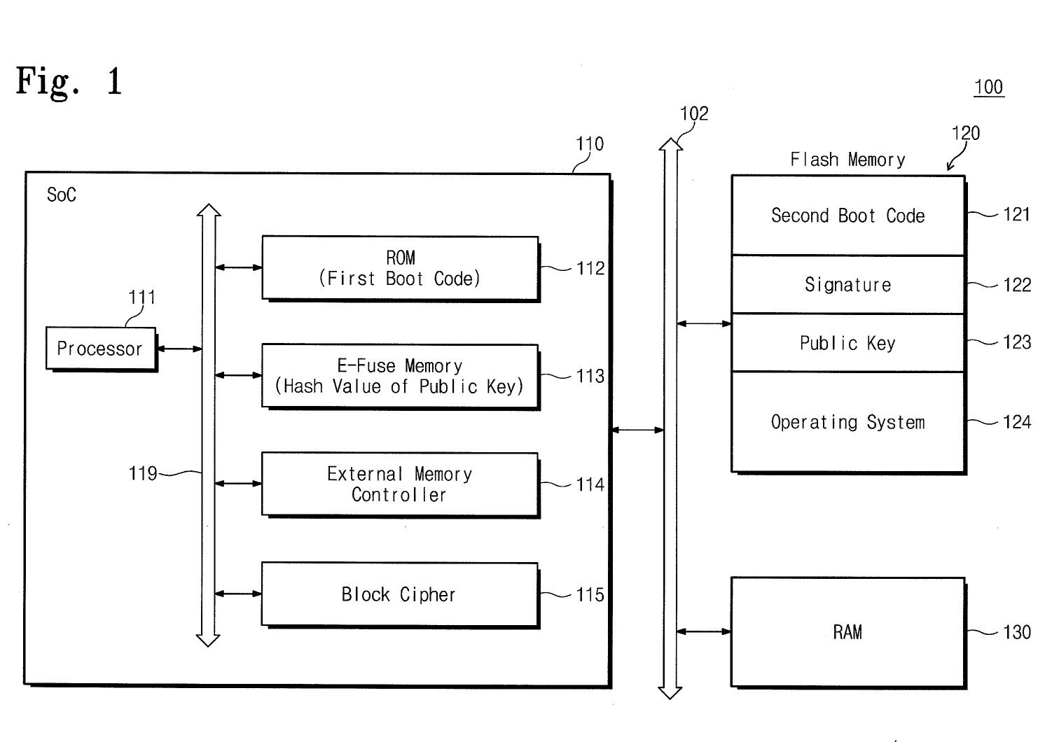

FIG. 1 is a block diagram of an electronic device according to an exemplary embodiment of the present invention.

Referring to FIG. 1, the electronic device 100 is comprised of a system-on-chip (SoC) 110, a flash memory 120, and a random access memory (RAM) 130, which are connected to each other by way of a system bus 102. The SoC 110 includes a processor 111, a read-only memory (ROM) 112, an electrical fuse memory (E-fuse memory) 113, an external memory controller 114, and a block cipher 115, which are connected to each other through an internal bus 119.

The flash memory 120 may be an external memory that is placed outside of the SoC 110. The flash memory 120 stores a boot code (or a bootstrap code) 121, an electronic signature 122, a public key 123, and an operating system (OS) program 124. The electronic signature 122 and the public key 123 are provided to authenticate that the boot code 121 of the flash memory 120 is permitted for the electronic device 100. In a boot-up process, the processor 111 authenticates the electronic signature 122 and the public key 123. If the electronic signature 122 and the public key 123 are authenticated as being reliable, the boot code 121 continues to be executed. If the electronic signature 122 and the public key 123 are not authenticated, the boot-up process is terminated.

Completing the boot-up process with the boot code 121 that is stored in the flash memory 120, the OS program 124 is loaded into the RAM 130 and then the electronic device 100 begins to conduct various application programs.

The processor 111 is used for processing almost all of the functions in the electronic device 100, which needs to be booted up prior to performing these functions. The ROM 112 stores a boot code 112 for the SoC 110. The boot code 121 stored in the flash memory 120 may be referred to as ‘second boot code’ and the boot code 112 stored in the ROM 112 may be referred to as ‘first boot code’.

The E-fuse memory 113 stores a hash value of the public key 123 that is reserved in the flash memory 120. Especially, the E-fuse memory 113 according to an exemplary embodiment of the present invention stores a hash value which is obtained by block encryption by dividing the public key 123 into a plurality of bit blocks. This block encryption algorithm accepts a part of the public key 123 as an initial input value. Such a hash value obtained by the block encryption algorithm is composed of 128 bits, instead of 160, 256, or 512 bits, and can help in reducing a size and product cost of the E-fuse memory 113. Moreover, there is no need to prepare an initial-value storage region because the initial value is taken from a part of the public key 123 not from additional storage.

The external memory controller 114 controls access to the flash memory 120. The block cipher 115 obtains hash values respective to the public key 123 and the second boot code 121 which are read from the flash memory 120 under control of the processor 111 during the boot-up process. The block cipher 115 can be activated any time there is a need for calculating a hash value even, for example, in an operation of the electronic device 100, or during the boot-up process.

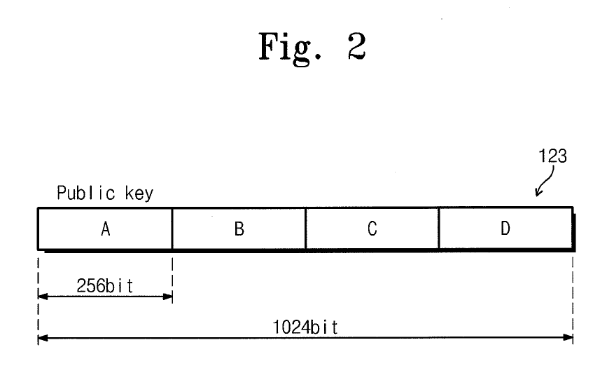

FIG. 2 shows the public key 123 divided into four blocks to obtain a hash value thereof, in accordance with an exemplary embodiment of the present invention. Referring to FIG. 2, the public key 123 is 1024 bits in size and each of the four blocks A, B, C, and D (A˜D) is 256 bits in size.

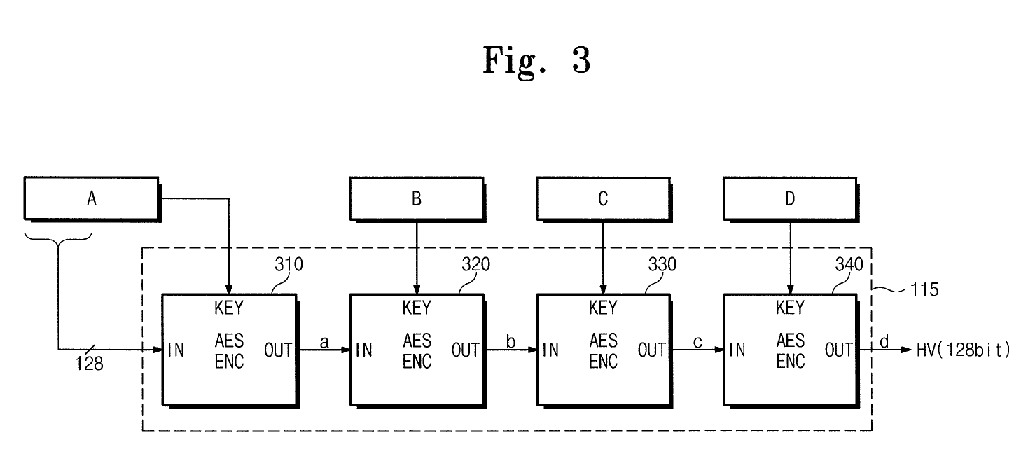

FIG. 3 is a block diagram of the block cipher 115 shown in FIG. 1 in accordance with an exemplary embodiment of the present invention.

Referring to FIG. 3, the block cipher 115 includes four encryption blocks 310˜340. The encryption blocks 310˜340 are connected to each other in series, each of which is formed of an advanced encryption standard (AES) cipher. As illustrated in FIG. 2, the public key 123 is divided into the four blocks A˜D. The four blocks A˜D of the public key 123 are provided as key values KEY respective to their corresponding encryption blocks 310˜340. Since the 128 bits of the first block A of the public key 123 are provided as the initial value of the first encryption block 310, it is unnecessary to prepare an additional memory for storing the initial value.

The encryption block 310 receives the 128 bits of the first block A and the first block A of the public key 123, and then outputs an encryption value a. The encryption block 320 receives the encryption value a and the second block B of the public key 123, and then outputs an encryption value b. The encryption block 330 receives the encryption value b and the third block C of the public key 123, and then outputs an encryption value c. The encryption block 340 receives the encryption value c and the fourth block D of the public key 123, and then outputs an encryption value d. The encryption value d output from the encryption block 340 is a hash value HV 128 bits in size.

The coded hash value HV is stored in the E-fuse memory 113 by means of the block cipher 115 while manufacturing the SoC 110. During the boot-up process of the electronic device 100, the block cipher 115 calculates the hash value HV from the public key 123 stored in the flash memory 120, and the processor 111 verifies the reliability of the boot code 121 of the flash memory 120 by determining whether a hash value stored in the E-fuse memory 113 agrees with the hash value HV calculated by the block cipher 115.

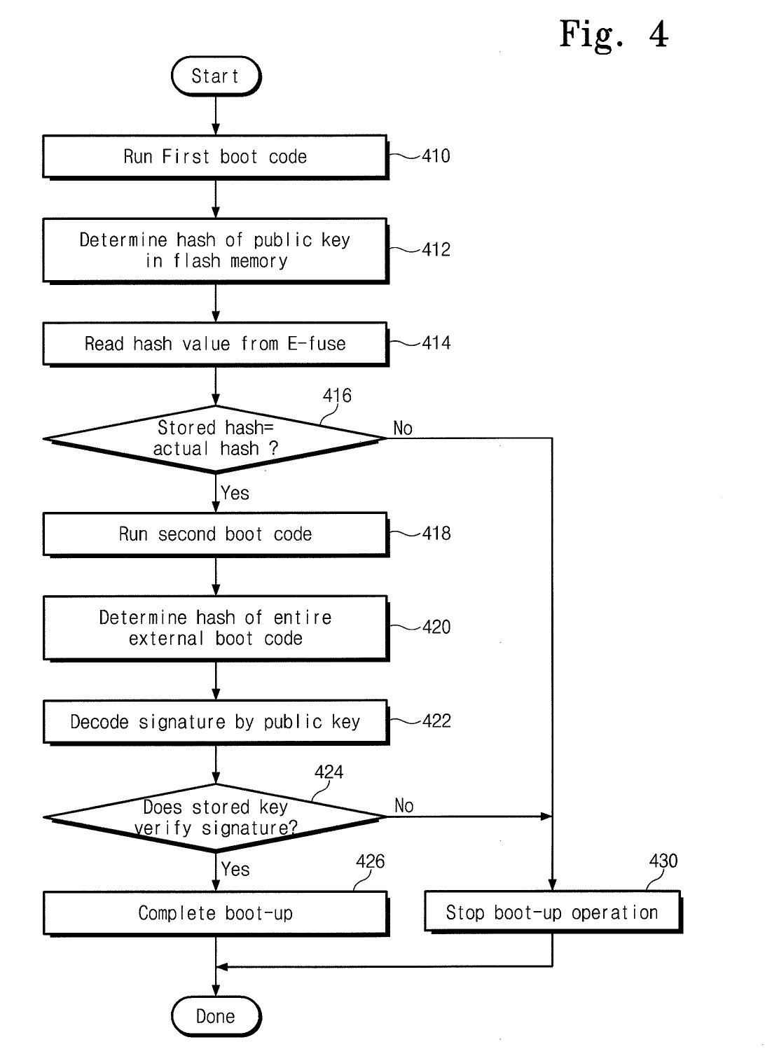

The boot-up process of the electronic device 100 will be described with reference to the flow chart shown in FIG. 4.

Referring to FIG. 4, if the electronic device 100 is powered on or reset, the processor 111 invokes the boot code 112 from the ROM 112 and executes the boot code 112 (410). The boot code 112 stored in the ROM 112 contains a series of commands for accessing the flash memory 120.

The processor 111 enables the hash value HV to be calculated by the block cipher 115 from the public key 123 stored in the flash memory 120 (412). The processor 111 reads a hash value from the E-fuse memory 113 (414). If the hash value of the E-fuse memory 113 is identical to the hash value HV calculated by the block cipher 115, the next boot-up process proceeds (416). If the two hash values are not identical to each other, the boot-up process is terminated (430).

The processor 111 relies on and executes the second boot code 121 when the hash value of the E-fuse memory 113 is identical to the hash value HV calculated by the block cipher 115 (418).

The processor 111 receives the second boot code 121 from the flash memory 120 and obtains a hash value of the entire second boot code 121 by controlling the block cipher 115 (420). The processor 111 decrypts the electronic signature 122 by means of the public key 123 stored in the flash memory 120 (422). The decrypted electronic signature is a hash value of the second boot code 121. In other words, the electronic signature 122 results from, in a process of manufacturing the electronic device 100, obtaining a hash value of the second boot code 121 while storing the second boot code 121 in the flash memory 120 and encrypting the obtained hash value by means of the public key 123. This encrypted value is the electronic signature 122. The security of the second boot code 121 can be authenticated by the electronic signature 122 and the security of the electronic signature 122 can be confirmed by the public key 123.

The processor 111 verifies the reliability of the electronic signature 122 by comparing the decrypted value of the electronic signature 122 to the hash value of the entire second boot code 121 which is calculated by the block cipher 115 (424).

If the electronic signature 122 is authenticated, the processor 111 runs the rest of the boot-up process of the second boot code 121 (426) and executes various application programs by loading the OS program 124 into the RAM 130.

If the hash value of the entire second boot code 121, which is calculated by the block cipher 115, is different from the decrypted value of the electronic signature 122, the processor 111 regards the contents of the flash memory 120 as changed and then terminates the boot-up process (430).

In accordance with an exemplary embodiment of the present invention, the electronic device 100 can be booted up with security. In particular, the hash value can be reduced to 128 bits in size because a block encryption algorithm is used for obtaining the hash value to the public key 123 stored in the E-fuse memory 113. As a result, it scales down the SoC 110 that includes the E-fuse memory 113.

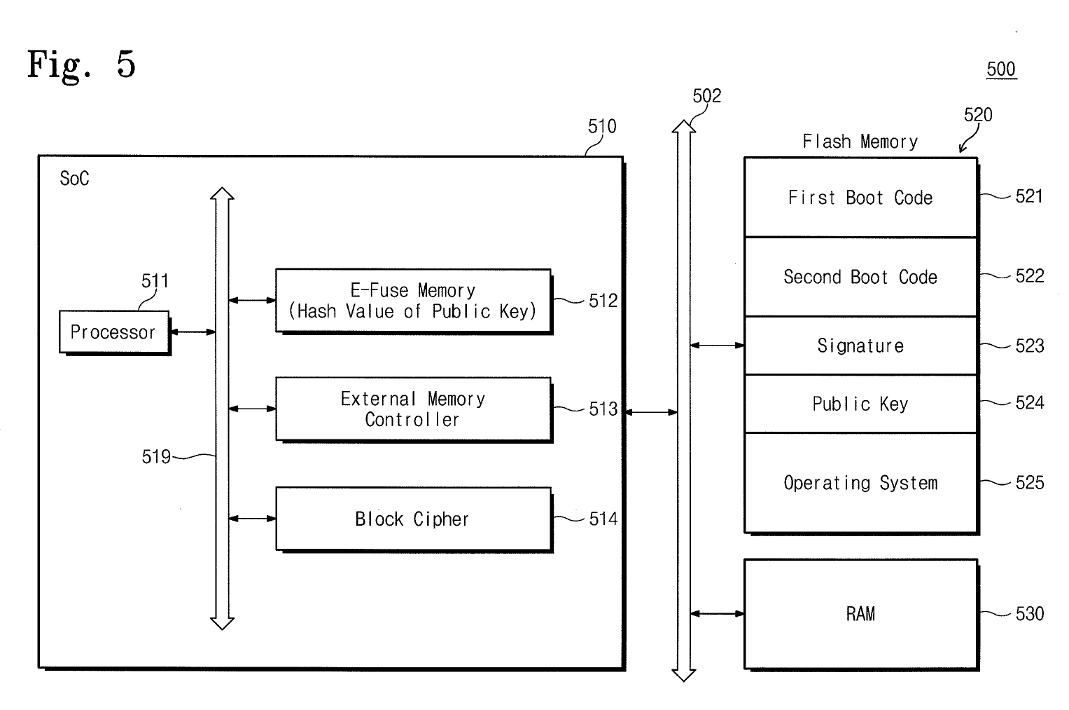

FIG. 5 is a block diagram of an electronic device according to an exemplary embodiment of the present invention.

The electronic device 500 shown in FIG. 5 is similar to that shown in FIG. 1, except that a first boot code is stored in an external flash memory 520 instead of the ROM 112.

In a boot-up process of the electronic device 500, a processor 511 of a SoC 510 executes a second boot code 522 after conducting the first boot code 521 that is stored in the external flash memory 520. After conducting the first boot code 521, the procedure for authenticating the second boot code 522 as described in conjunction with FIG. 4 is performed, so no further detail will be provided.

In accordance with an exemplary embodiment of the present invention, a secure boot-up process is carried out to assure that unauthorized software code is not executed on an electronic device. As described above, by abbreviating the hash code, which is stored in the E-fuse memory, to 128 bits instead of 160, 256, or 512, a size and cost of the E-fuse memory can be reduced. In addition, since part of a public key is used as an initial value to a block cipher, there is no need to prepare an initial value storage region. Further, since the block cipher is implemented in hardware by an AES cipher, it has an enhanced encryption rate.

Exemplary embodiments of the present invention may not be restricted to a specific use. For example, exemplary embodiments of the present invention are enabled to be used in a variety of applications, for instance, in smart cards employing ISO 7816 series (e.g., ISO 7816-1, ISO 7816-2, and ISO 7816-3), contactless and proximity smart cards and cryptographic tokens, cryptographically secured credit and debit cards, customer loyalty cards and systems, cryptographically authenticated credit cards, cryptographic accelerators, gambling and wagering systems, cryptographic secure chips, tamper-resistant microprocessors, software programs (all kinds embeddable and loadable in cryptographic devices, but not limited to programs used in personal computers or servers), key management systems, banking-key management systems, secure web servers, electronic payment systems, micro-payment systems, prepaid telephone cards, secure identification (ID) cards, ID verification systems, systems for electronic finds transfer, automatic teller machines, point-of-sale (POS) systems, certification issuance systems, electronic badges, door entry systems, all kinds of physical locks using cryptographic keys, systems for decrypting television signals (e.g., broadcasting televisions, satellite televisions, or cable televisions), cryptographic music and audio contents decrypting systems (including music distribution over computer networks), all kinds of video signal protection systems, protection systems for intellectual properties and copies to movies, audio contents, computer programs, video games, images, texts, data bases, and so forth, cellular phone scrambling and authentication systems, cryptographic personal computer memory card international association (PCMCIA) cards, portable cryptographic tokens, or cryptographic data and auditing systems.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for authenticating a public key to execute a process with security, comprising:
invoking a process;
reading a public key from a first source;
calculating a hash value of the public key with a block encryption algorithm,
wherein part of the public key is an initial input value of the block encryption algorithm;
reading a hash value from a second source;
comparing the calculated hash value to the read hash value to determine if the public key is authentic; and
executing the process if the public key is authentic.

2. The method as set forth in claim 1, wherein calculating the hash value comprises:
dividing the public key into a plurality of bit blocks;
providing each of the bit blocks to a respective block cipher as a key, wherein the block ciphers are connected in series;
providing part of one of the plurality of bit blocks to a first one of the block ciphers as the initial input value; and
conducting a block encryption in each of the block ciphers on its input value in accordance with its key.

3. The method as set forth in claim 2, wherein the hash value is an output of a last one of the block ciphers.

4. The method as set forth in claim 2, wherein each block cipher employs an advanced encryption standard algorithm.

5. The method as set forth in claim 1, wherein the hash value has a smaller number of bits than the public key.

6. The method as set forth in claim 1, wherein the hash value comprises 128 bits.

7. A secure boot-up method for an electronic device, comprising:
reading a public key from a first memory;
calculating a first hash value of the public key with a block encryption algorithm;
reading a second hash value from a second memory, wherein the second hash value is a hash value of a public key that is permitted for the electronic device and is calculated with the block encryption algorithm;
comparing the first hash value with the second hash value; and
executing a boot code of the first memory if the first hash value is equal to the second hash value.

8. The method as set forth in claim 7, wherein calculating each hash value with the block encryption algorithm comprises:
dividing its respective public key into a plurality of bit blocks;
providing each of the plurality of bit blocks to a respective block cipher as a key, wherein the block ciphers are connected in series;
providing part of one of the plurality of bit blocks to a first one of the block ciphers as an initial input value; and
conducting a block encryption in each of the block ciphers on its input value in accordance with its key.

9. The method as set forth in claim 8, wherein each hash value is an output of a last one of the block ciphers.

10. The method as set forth in claim 8, wherein each block cipher employs an advanced encryption standard algorithm.

11. The method as set forth in claim 7, wherein each hash value has a smaller number of bits than its respective public key.

12. The method as set forth in claim 7, wherein each hash value comprises 128 bits.

13. The method as set forth in claim 7, wherein the first memory is a flash memory and the second memory is an electrical fuse memory.

14. The method as set forth in claim 7, which further comprises:
calculating a hash value of the boot code of the first memory if the first hash value is equal to the second hash value;
decrypting an electronic signature, which is stored in the first memory, with the public key from the first memory;
determining whether the hash value of the boot code of the first memory is equal to the decrypted electronic signature; and
executing a remainder of the boot code of the first memory if the hash value of the boot code of the first memory is equal to the decrypted electronic signature.

15. An electronic device, comprising:
a first memory storing a boot code and a public key;
a processor executing the boot code;
a second memory storing a first hash value; and
a block cipher calculating a second hash value from the public key with a block encryption algorithm,
wherein part of the public key is an initial input value of the block cipher, and
wherein the first hash value stored in the second memory is obtained by hashing a public key that is permitted for the electronic device with the block encryption algorithm, which uses part of the public key that is permitted for the electronic device as its initial input value.

16. The electronic device as set forth in claim 15, which further comprises a third memory that stores a boot code, wherein the boot code of the third memory comprises command codes enabling the processor:
to calculate the second hash value from the public key stored in the first memory;
to read the first hash value from the second memory;
to determine whether the first hash value read from the second memory is equal to the second hash value; and
to execute the boot code of the first memory if the first hash value read from the second memory is equal to the second hash value.

17. The electronic device as set forth in claim 16, wherein the boot code of the first memory comprises command codes enabling the processor:
to calculate a hash value of the boot code of the first memory if the first hash value read from the second memory is equal to the second hash value;
to decrypt an electronic signature, which is stored in the first memory, with the public key from the first memory;
to determine whether the hash value of the boot code of the first memory is equal to the decrypted electronic signature; and
to terminate a boot-up process if the hash value of the boot code of the first memory is not equal to the decrypted electronic signature.

18. The electronic device as set forth in claim 15, wherein the block cipher comprises a plurality of encryption blocks connected to each other in series, each receiving a key value and an input value, and
wherein each encryption block, except a first one of the encryption blocks receives an output of a previous encryption block as the input value.

19. The electronic device as set forth in claim 18, wherein the public key from the first memory is divided into a plurality of bit blocks respective to the plurality of encryption blocks, each bit block is provided to its corresponding encryption block as the key value, and
wherein the first one of the plurality of encryption blocks receives part of the public key as the initial input value.

20. The electronic device as set forth in claim 15, wherein each hash value has a smaller number of bits than its respective public key.

21. The electronic device as set forth in claim 20, wherein each hash value comprises 128 bits.

22. The electronic device as set forth in claim 15, wherein the first memory is a flash memory and the second memory is an electrical fuse memory.

23. The electronic device as set forth in claim 22, which further comprises an internal memory,
wherein the internal memory, the processor, and the electrical fuse memory are integrated on a single chip.

24. The electronic device as set forth in claim 23, wherein during a boot-up process, the processor first executes a boot code stored in the internal memory and next executes the boot code of the flash memory that is external to the single chip.

25. The electronic device as set forth in claim 22, wherein the processor and the electrical fuse memory are integrated on a single chip and the flash memory is external to the single chip, and wherein during a boot-up process, the processor executes the boot code of the flash memory after executing an initial boot code stored in the flash memory.
